(19) United States
(12) Patent Application Publication
(10) Pub. No.: US 2024/0332847 A1
(43) Pub. Date: Oct. 3, 2024

(54) CONNECTOR ASSEMBLY AND WIRE CONNECTOR

(71) Applicant: BELLWETHER ELECTRONIC CORP., Taoyuan City (TW)

(72) Inventor: Ming-Hsun Yang, Taoyuan City (TW)

(21) Appl. No.: 18/395,723

(22) Filed: Dec. 25, 2023

Related U.S. Application Data
(60) Provisional application No. 63/455,563, filed on Mar. 30, 2023.
(60) Provisional application No. 63/523,493, filed on Jun. 27, 2023.

(30) Foreign Application Priority Data
Aug. 21, 2023 (TW) 112131297

(51) Int. Cl. H01R 13/502; H01R 12/73; H01R 13/629

(52) U.S. Cl. CPC H01R 13/502; H01R 12/73; H01R 13/629

(57) ABSTRACT

A connector assembly and a wire connector are provided. The connector assembly includes a board connector and a wire connector. The board connector includes a first connecting seat, a second connecting seat, and a metal shell. The first connecting seat has a first connecting slot, and the second connecting seat has a second connecting slot that is different from the first connecting slot. The first connecting seat and the second connecting seat are surrounded by the metal shell. The metal shell includes at least one first guide structure. The wire connector includes at least one second guide structure. When the wire connector is inserted into or removed from the board connector, the first guide structure and the second guide structure can cooperate with each other, so as to guide the at least one wire connector in being inserted into or removed from the board connector.

### CROSS-REFERENCE TO RELATED PATENT APPLICATION

This application claims the benefit of priority to Taiwan Patent Application No. 112131297 filed on Aug. 21, 2023, and the benefit of priorities to the U.S. Provisional Patent Application Ser. No. 63/455,563 filed on Mar. 30, 2023 and Ser. No. 63/523,493 filed on Jun. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a connector assembly and a wire connector, and more particularly to a connector assembly that has a board connector including two different connecting slot types and a wire connector mated with the board connector.

### BACKGROUND OF THE DISCLOSURE

A conventional board connector may have two connecting slots of different types (e.g., a power connecting slot and a signal connecting slot). During the process of separating a mating conventional wire connector from the conventional board connector, due to the inconsistent frictional force required for different connecting slots, a situation where one end of the conventional wire connector has completely detached from the conventional board connector while the other end of the conventional wire connector has not yet fully disconnected from the conventional board connector can often occur. As a result, the conventional wire connector as a whole will appear to be in a tilted state, and the related connection board (or guide board) of the conventional wire connector is easily damaged.

### SUMMARY OF THE DISCLOSURE

In response to the above-referenced technical inadequacies, the present disclosure provides a connector assembly and a wire connector that have two different types of connecting slots, and can improve on a problem of a deviation occurring during the process of detaching the wire connector from the board connector (which can lead to structural damage to the wire connector).

In order to solve the above-mentioned problems, one of the technical aspects adopted by the present disclosure is to provide a connector assembly. The connector assembly includes a board connector and at least one wire connector. The board connector is configured to be fixed on a circuit board, and the board connector includes at least one first connecting seat, at least one second connecting seat, and a metal shell. The at least one first connecting seat is disposed on the circuit board. The at least one first connecting seat includes a first connecting slot. The at least one second connecting seat is disposed on the circuit board. The at least one second connecting seat includes a second connecting slot that is different from the first connecting slot. The at least one first connecting seat and the at least one second connecting seat are surrounded by the metal shell, and the metal shell includes at least one first guide structure. The at least one wire connector is configured in being inserted into the board connector, and the at least one wire connector includes at least one second guide structure. When the at least one wire connector is inserted into or removed from the board connector, the first guide structure and the second guide structure is capable of cooperating with each other, so as to guide the at least one wire connector in being inserted into or removed from the board connector.

In order to solve the above-mentioned problems, one of the technical aspects adopted by the present disclosure is to provide a wire connector for connecting with a board connector having a metal shell. The wire connector includes an insulating body, a first connecting plate, a first ribbon wire, and at least one limiting structure. The first connecting plate is disposed on a surface and is perpendicular to an end surface of the insulating body. A surface of the first connecting plate has a plurality of first gold fingers. The first ribbon wire is electrically connected to the first gold fingers of the first connecting plate, and the first ribbon wire protrudes from a side surface that is adjacent to the end surface. The at least one limiting structure protrudes vertically from the end surface, and is parallel to the first connecting plate. The at least one limiting structure has a second guide structure to match a first guide structure on the metal shell, so as to guide the wire connector in being inserted into or removed out of the board connector.

Therefore, by virtue of “the first guide structure and the second guide structure,” the connector assembly of the present disclosure can significantly reduce the occurrence of tilting when detaching the wire connector from the board connector. Accordingly, the wire connector and the board connector can be connected and separated along the correct mating direction, and the damage to the wire connector can be effectively reduced during the process of inserting and detaching the wire connector from the board connector.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a connector assembly in a mated state according to a first embodiment of the present disclosure;

FIG. 2 is a schematic view of the connector assembly in an unmated state according to the first embodiment of the present disclosure;

FIG. 3 is a schematic top view of a board connector of the connector assembly according to the first embodiment of the present disclosure;

FIG. 4 is a schematic view of a wire connector of the connector assembly according to the first embodiment of the present disclosure;

FIG. 5 is a schematic partial cross-sectional view of the connector assembly according to the first embodiment of the present disclosure;

FIG. 6 is a schematic view of the connector assembly in a mated state according to a second embodiment of the present disclosure;

FIG. 7 is a schematic view of the connector assembly in an unmated state according to the second embodiment of the present disclosure;

FIG. 8 is a schematic enlarged view of a section of FIG. 7;

FIG. 9 is a schematic enlarged view of a section of the connector assembly according to the second embodiment of the present disclosure;

FIG. 10 is a schematic enlarged view of a section of the connector assembly according to a third embodiment of the present disclosure;

FIG. 11 is a schematic view of a section of the connector assembly in a mated state according to a fourth embodiment of the present disclosure;

FIG. 12 is a schematic operational view of the wire connector of the connector assembly according to the fourth embodiment of the present disclosure;

FIG. 13 is a schematic view of a wire connector of the connector assembly according to a fifth embodiment of the present disclosure;

FIG. 14 is a schematic view of a wire connector of the connector assembly according to a sixth embodiment of the present disclosure;

FIG. 15 is a schematic view of a wire connector of the connector assembly according to a seventh embodiment of the present disclosure; and

FIG. 16 is a schematic view of a wire connector of the connector assembly according to an eighth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

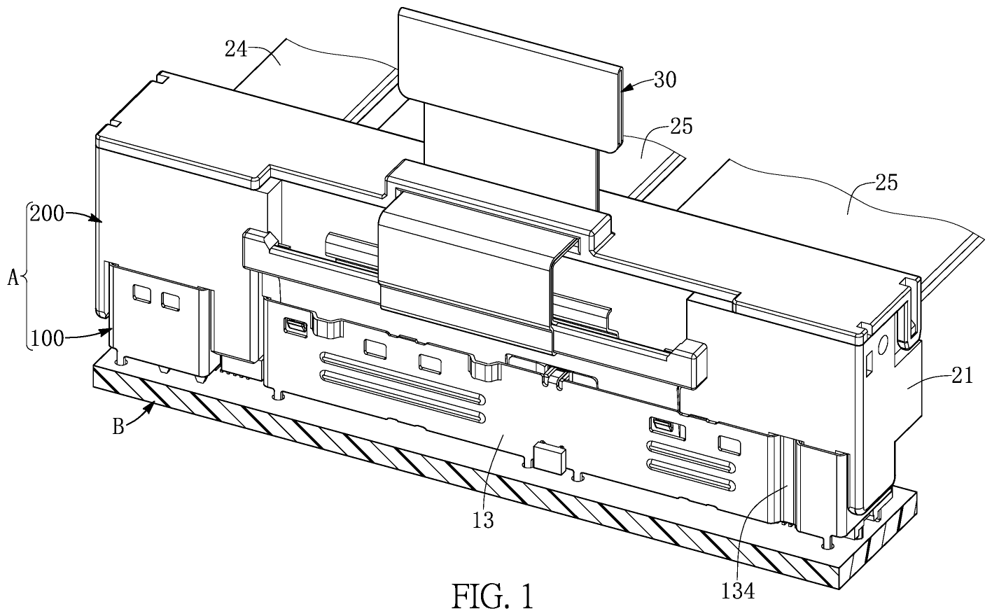

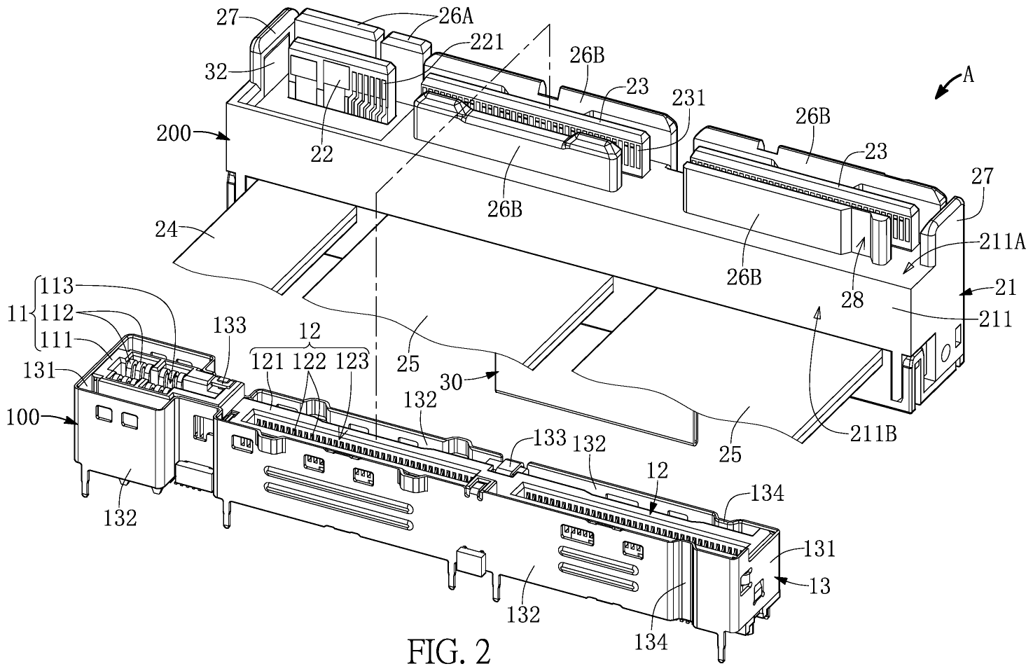

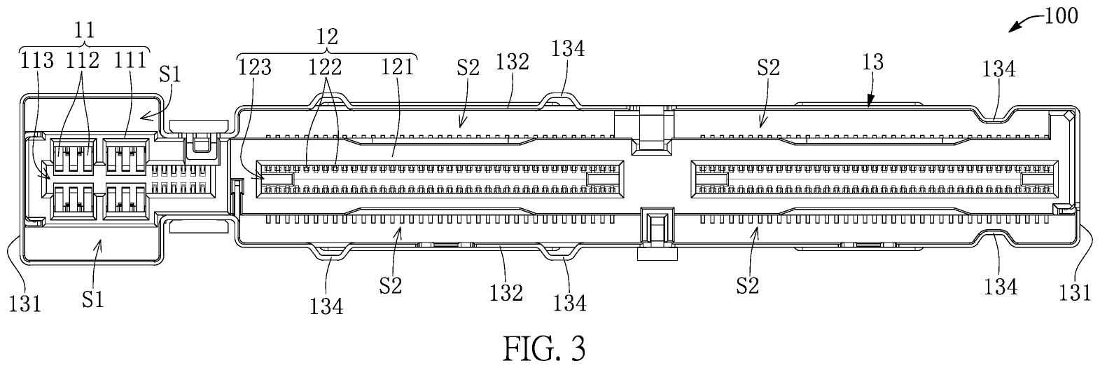

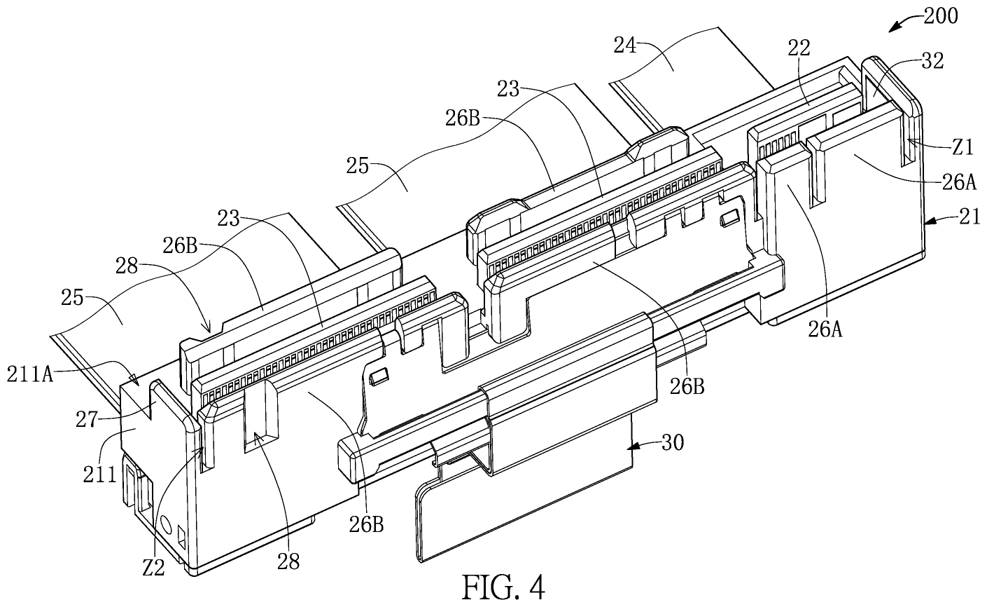

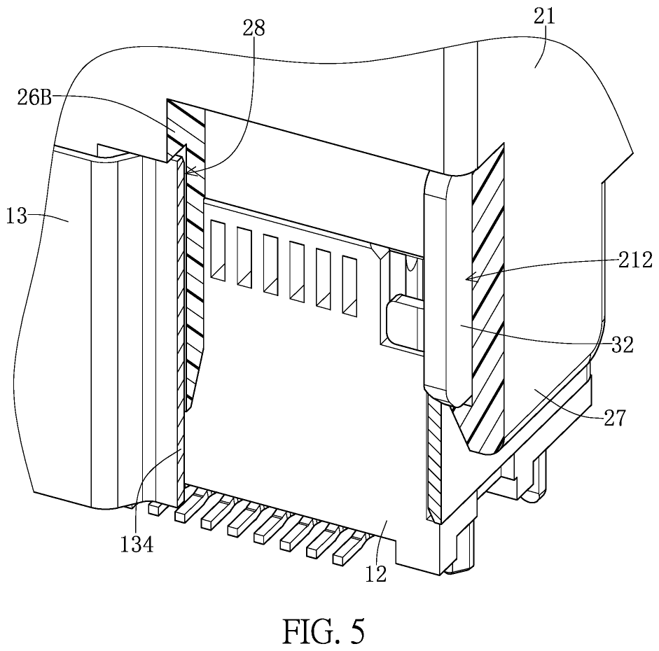

Referring to FIG. 1 to FIG. 5, FIG. 1 is a schematic view of a connector assembly in a mated state according to a first embodiment of the present disclosure, FIG. 2 is a schematic view of the connector assembly in an unmated state according to the first embodiment of the present disclosure, FIG. 3 is a schematic top view of a board connector of the connector assembly according to the first embodiment of the present disclosure, FIG. 4 is a schematic view of a wire connector of the connector assembly according to the first embodiment of the present disclosure, and FIG. 5 is a schematic partial cross-sectional view of the connector assembly according to the first embodiment of the present disclosure.

The connector assembly A of the present disclosure includes a board connector 100 and a wire connector 200. The board connector 100 is configured to be mounted on a circuit board B. The board connector 100 in the present embodiment includes a first connecting seat 11, two second connecting seats 12, and a metal shell 13. In practical applications, the board connector 100 can include at least one first connecting seat 11 and at least one second connecting seat 12, or the board connector 100 can include three or more different connecting seats, either integrally formed or independently connected through a snap-fit mechanism. The quantity of the first connecting seats 11 and the second connecting seats 12 included in the board connector 100 is not limited to the configuration shown in drawings of the present embodiment. The first connecting seat 11 and the two second connecting seats 12 can be arranged in a row on the circuit board B. However, the arrangement of the first connecting seat 11 and the two second connecting seats 12 on the circuit board B is not limited to the configuration shown in the drawings.

The first connecting seat 11 includes a first insulating base 111 disposed on the circuit board B, and a plurality of first connection terminals 112 that are disposed in the first insulating base 111. The first connection terminals 112 and the first insulating base 111 together form a first connecting slot 113. Each of the two second connecting seats 12 includes a second insulating base 121 disposed on the circuit board B, and a plurality of second connection terminals 122 that are disposed in the second insulating base 121. The second connection terminals 122 and the second insulating base 121 together form a second connecting slot 123.

The first connecting slot 113 is not the same as the second connecting slot 123. For example, in one of the embodiments, the first connecting slot 113 of the first connecting seat 11 is used to transmit power (including power-related signals), and the second connecting slot 123 of each of the two second connecting seats 12 is used to transmit signals. In other words, the quantity of the first connection terminals 112 included in the first connecting seat 11 and/or the outer appearance of at least one part of the first connection terminals 112 may differ from the quantity of the second connection terminals 122 included in the two second connecting seats 12 and/or the outer appearance of at least one part of the second connection terminals 122, but the specific uses of the first connecting seat 11 and the two second connecting seats 12 are not limited thereto. The first connecting slot 113 and the second connecting slot 123 are arranged in a straight line, that is, the first connecting slot 113 and the second connecting slot 123 are on the same plane.

The first connecting seat 11 and the two second connecting seats 12 are surrounded by the metal shell 13. The metal shell 13 can be exemplified to include two first side walls 131 (i.e., two short side walls), two second side walls 132 (i.e., two long side walls), and a plurality of clamping structures 133. Two ends of each of the two first side walls 131 are respectively connected to two ends of each of the two second side walls 132, the two first side walls 131 are arranged facing each other, and the two second side walls 132 are arranged facing each other. The two first side walls 131 and the two second side walls 132 may together form a substantially closed structure. The outer appearance and size of the metal shell 13 can be adjusted according to the quantity, shape and size of the first connecting seat 11 and the two second connecting seats 12. However, the present disclosure is not limited thereto.

The clamping structures 133 are disposed on at least one of the first insulating base 111 of the first connecting seat 11, the second insulating base 121 of one of the two second connecting seats 12, a connecting portion between the first insulating base 111 and the adjacent second insulating base 121, and a connecting portion between the adjacent second insulating bases 121. The metal shell 13 is connected to the first connecting seat 11 and the two second connecting seats 12 through the clamping structures 133. The metal shell 13 can also include a plurality of pins, and the pins are used to be fixed on the circuit board B. The metal shell 13 can be electrically connected to a ground of the circuit board through the pins. In one of the embodiments when the metal shell 13 is grounded through the circuit board B, the metal shell 13 may have an electromagnetic shielding function.

The metal shell 13 is arranged around the first connecting seat 11 and the two second connecting seats 12, with one or more gaps between them. Specifically, at least one first gap S1 is between the metal shell 13 and the first insulating base 111 of the first connecting seat 11, and at least one second gap S2 is also between the metal shell 13 and the second insulating base 121 of one of the two second connecting seats 12. In the present embodiment, two long side walls of the metal shell 13 and two long side walls of the first connecting seat 11 respectively have the first gap S1 there-between, and the two long side walls of the metal shell 13 and two long side walls of each of the second connecting seats 12 respectively have the second gap S2 there-between.

The metal shell 13 can include a plurality of first guide structures 134. The first guide structures 134 may be formed on the two second side walls (long side walls) 132 of the metal shell 13, and the first guide structures 134 may be disposed substantially facing each other. Moreover, the first guide structures 134 may be disposed adjacent to at least one of the two second connecting seats 12. In other words, the metal shell 13 can have the first guide structures 134 formed in a section adjacent to the two second connecting seats 12. Each of the first guide structures 134 can be exemplified to be a convex structure formed by the inward bending of the metal shell 13, or a concave structure formed by the outward bending of the metal shell 13. The outer appearance, forming method and setting position of the first guide structures 134 are not limited thereto. It should be noted that the first guide structures 134 can also be disposed adjacent to each of the two second connecting seats 12, or at least one of the first guide structures 134 may also be disposed adjacent to the first connecting seat 11.

In a preferred one of the embodiments, the metal shell 13 may include an even number of the first guide structures 134. Half of the first guide structures 134 are provided on one of the two second side walls 132, and another half of the first guide structures 134 are provided on another one of the two second side walls 132. Any one of the first guide structures 134 is arranged facing another one of the first guide structures 134.

The wire connector 200 is used by being inserted into the board connector 100. In the present embodiment, the wire connector 200 includes an insulating body 21, a first connecting plate 22, two second connecting plates 23, a first ribbon wire 24, two second ribbon wires 25, a plurality of inner limiting structures, two anti-tilt insertion structures 27, and two second guide structures 28.

The first connecting plate 22 and the two second connecting plates 23 are printed wire boards, and are arranged in a row (i.e., the first connecting plate 22 and the two second connecting plates 23 are on the same plane). The first connecting plate 22 has a plurality of first gold fingers 221, and each of the two second connecting plates 23 has a plurality of second gold fingers 231. The first gold fingers 221 may be formed on a single side or both sides of the first connecting plate 22, and the second gold fingers 231 may be formed on a single side or both sides of one of the two second connecting plates 23. The quantity of the first gold fingers 221 included in the first connecting plate 22 is different from the quantity of the second gold fingers 231 included in each of the two second connecting plates 23, or a width of at least one of the second gold fingers 231 is different from a width of at least one of the first gold fingers 221.

The insulating body 21 may include an end portion 211, and front ends of the first connecting plate 22 and the two second connecting plates 23 protrude from an end surface 211A of the end portion 211. Each of the first connecting plate 22 and the two second connecting plates 23 may be disposed on and perpendicular to the end surface 211A. The inner limiting structures may be formed by extending outward from the end surface 211A, and the inner limiting structures are substantially plate-shaped.

The first ribbon wire 24 is electrically connected to the first gold fingers of the first connecting plate 22, and the second ribbon wires 25 are electrically connected to the second gold fingers of the two second connecting plates 23. The first ribbon wire 24 and the second ribbon wires 25 are side out wires, and protrude outward from a side surface 211B adjacent to the end surface 211A of the insulating body 21. That is, the first ribbon wire 24 and the second ribbon wires 25 may be substantially perpendicular to the first connecting plate 22 and the two second connecting plates 23.

When the wire connector 200 and the board connector 100 are mated with each other, the first connecting plate 22 and the two second connecting plates 23 are correspondingly inserted into the first connecting slot 113 and the second connecting slots 123, so that the first connecting plate 22, the first ribbon wire 24, the first connection terminals 112 and the circuit board B can be electrically connected, and the two second connecting plates 23, the second ribbon wires 25, the second connection terminals 122 and the circuit board B can also be correspondingly and electrically connected.

A plurality of limiting structures may be formed by extending outward from the end surface 211A of the insulating body 21, the limiting structures can be arranged in parallel with the first connecting plate 22, and the limiting structures can be located on one side or two opposite sides of the first connecting plate 22 and the two second connecting plates 23. For illustration purposes, the inner limiting structures in the present embodiment are defined as first inner limiting structures 26A and second inner limiting structures 26B according to the locations of the inner limiting structures. Two first inner limiting structures 26A may be arranged in a straight line, and the two first inner limiting structures 26A may be located on one side of the first connecting plate 22. For example, each of the two first inner limiting structures 26A may be located between the first connecting plate 22 and the first ribbon wire 24. Two second inner limiting structures 26B may be disposed on both sides of one of the two second connecting plates 23, and another two of the second inner limiting structures 26B may be disposed on both sides of another one of the two second connecting plates 23.

When the wire connector 200 and the board connector 100 are connected to each other, each of the first inner limiting structures 26A and the second inner limiting structures 26B correspond in position to the first gap S1 and the second gap S2, respectively. By virtue of “the first inner limiting structures 26A and the second inner limiting structures 26B”, the wire connector 200 can achieve anti-fooling and guiding effects during the process of inserting into the board connector 100. Thereby, the first connecting plate 22 and the two second connecting plates 23 are assisted to correctly insert into the first connecting slot 113 and the second connecting slots 123 along a mating direction. The size, outer appearance, quantity, and location of the first inner limiting structures 26A and the second inner limiting structures 26B can be adjusted according to practical requirements, and the present disclosure is not limited thereto.

The two anti-tilt insertion structures 27 can be exemplified to be formed by extending outward from the end surface 211A, and the two anti-tilt insertion structures 27 are located on both sides of the end portion 211 of the insulating body 21. A reserved space is between each of the two anti-tilt insertion structures 27 and an adjacent one of the inner limiting structures.

Specifically, a first reserved space Z1 is between one of the two anti-tilt insertion structures 27 and an adjacent one of the first inner limiting structures 26A, and a second reserved space Z2 is between the other one of the two anti-tilt insertion structures 27 and an adjacent one of the second inner limiting structures 26B. Each of the reserved spaces (i.e., the first reserved space Z1 and the second reserved space Z2) is used to accommodate a part of the metal shell 13.

Referring to FIG. 1 and FIG. 2, when the wire connector 200 is connected to the board connector 100, and the two anti-tilt insertion structures 27 correspond in position to outer sides of the two ends (i.e., the two first side walls 131) of the metal shell 13, the two anti-tilt insertion structures 27 are used to prevent the wire connector 200 from being inserted or removed from the board connector 100 in a tilted posture.

The second guide structures 28 are used to connect with the first guide structures 134. The second guide structures 28 included in the wire connector 200 correspond in position to the first guide structures 134 included in the board connector 100, and the quantity of the second guide structure 28 can be equal to or different from the first guide structures 134 (e.g., the same or fewer in quantity).

In the present embodiment, two second guide structures 28 may be respectively formed on two of the second inner limiting structures 26B, and the two second guide structures 28 are disposed adjacent to one of the two second connecting plates 23. The two second guide structures 28 may be located at an end of the wire connector 200 opposite to where the first connecting plate 22 is positioned. That is, the two second guide structures 28 and the first connecting plate 22 may be approximately located at a left end and a right end of the wire connector 200.

The second guide structures 28 may be groove structures formed on outer sides of the second inner limiting structures 26B and the first guide structures 134 are convex structures in the second gap S2. When the wire connector 200 is inserted into the board connector 100, the first guide structures 134 will cooperate with the second guide structures 28. By virtue of the first guide structures 134 and the second guide structures 28, when the wire connector 200 is inserted into the board connector 100, the first connecting plate 22 and the second connecting plates 23 can be inserted into the first connecting slot 113 and the second connecting slots 123 relatively easily and correctly.

Correspondingly, when the wire connector 200 is detached from the board connector 100, each of the second guide structures 28 will move relative to one of the first guide structures 134. Therefore, the moving direction of the wire connector 200 relative to the board connector 100 can be effectively limited, so that the wire connector 200 can detach from the board connector 100 in a vertical direction (i.e., in the opposite direction of the mating orientation). For this reason, a structure of the wire connector 200 can effectively avoid damage due to any improper force during the process of being detached from the board connector 100.

In addition, in one of the embodiments where the first connecting seat 11 and the second connecting seats 12 are respectively used to transmit power and signals, due to that the quantity of the first connection terminals 112 included in the first connecting seat 11 is small, and the first connection terminals 112 are relatively thicker and wider, while the quantity of each of the second connection terminals 122 included in the second connecting seat 12 is large, and the first connection terminals 112 are thinner and narrower, the force required for the first connecting plate 22 to detach from the first connecting slot 113 is greater than the force required for each of the second connecting plates 23 to detach from the second connecting slot 123. When the wire connector 200 is detached from the board connector 100, both ends of the wire connector 200 can be detached from of the board connector 100 at approximately the same time through the first guide structures 134 and the second guide structures 28.

In the above situation, by virtue of “the first guide structures 134 disposed on the board connector 100” and “the second guide structures 28 provided in a corresponding position of the wire connector 200, the wire connector 200 basically does not deviate (rotate) relative to the mating direction during the process of being detached from the board connector 100, so that the wire connector 200 may substantially move vertically upward relative to the board connector 100. Therefore, the wire connector 200 can effectively avoid damage during the process of being detached from the board connector 100.

In the above situation, a height of each of the first guide structures 134 may be approximately the same as a height of the metal shell 13, or may be less than half the height of the metal shell 13 (e.g., the first guide structures 134 can also be located only within an upper half of the metal shell 13). When the wire connector 200 is detached from the board connector 100, the first guide structures 134 and the second guide structures 28 will cooperate with each other to jointly limit a movement of the wire connector 200 relative to the board connector 100.

In the above situation, by virtue of “the first guide structures 134 and the second guide structures 28”, when the wire connector 200 is detached from the board connector 100, the wire connector 200 can also effectively prevent damage to the two anti-tilt insertion structures 27 due to the deviation of the wire connector 200.

### Second Embodiment

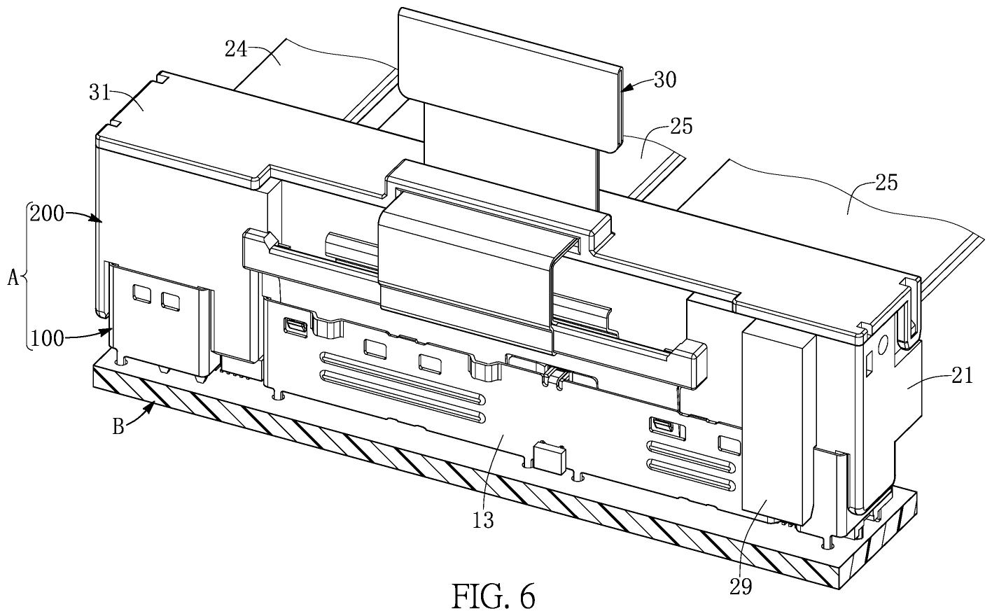

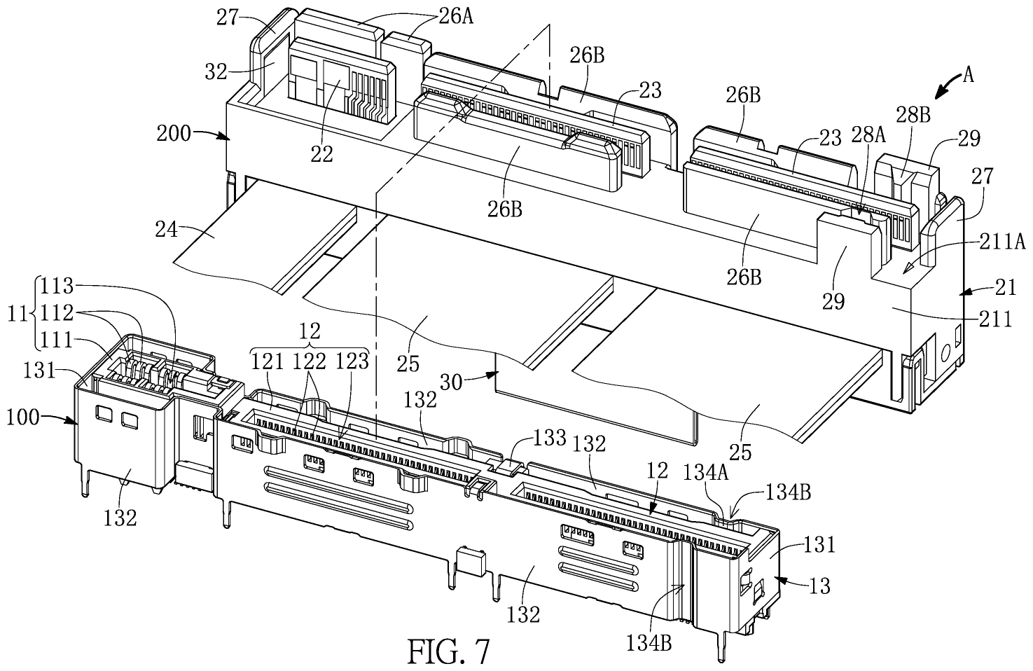

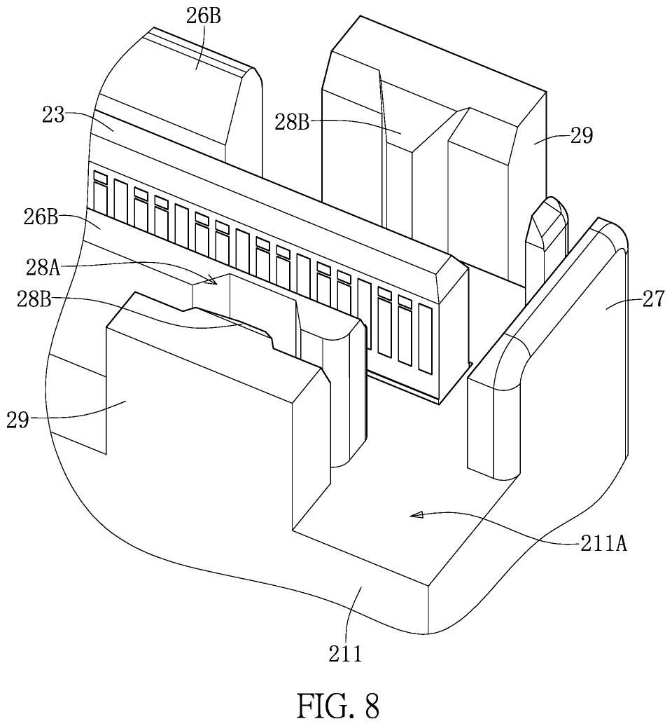

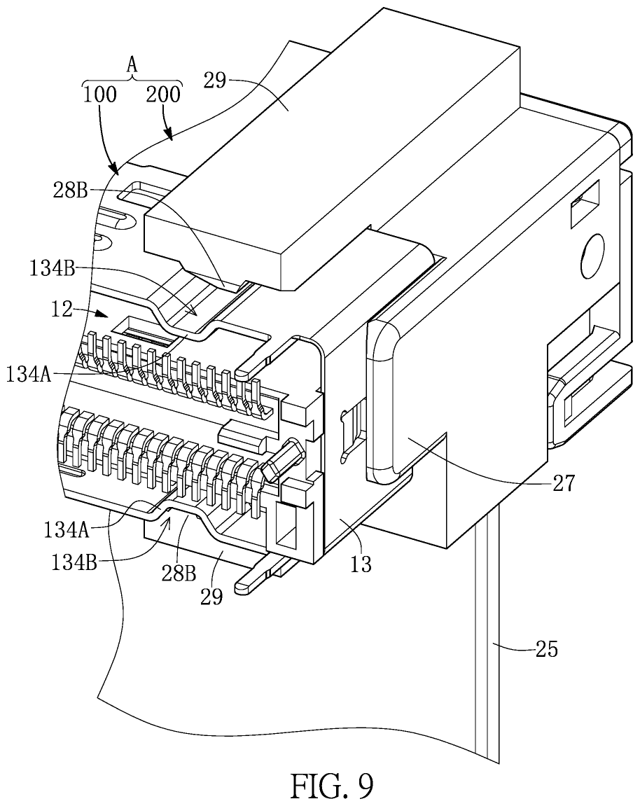

Referring to FIG. 6 to FIG. 9, FIG. 6 is a schematic view of the connector assembly in a mated state according to a second embodiment of the present disclosure, FIG. 7 is a schematic view of the connector assembly in an unmated state according to the second embodiment of the present disclosure, FIG. 8 is a schematic enlarged view of a section of FIG. 7, and FIG. 9 is a schematic enlarged view of a section of the connector assembly according to the second embodiment of the present disclosure. The board connector 100 of the present embodiment is the same as the board connector 100 of the first embodiment, and will not be described herein.

The difference between the present embodiment and the first embodiment mainly resides in that the wire connector 200 can also include two external limiting structures 29. Each of the two external limiting structures 29 may be formed by extending outward from the end surface 211A of the insulating body 21, and each of the two external limiting structures 29 is substantially a plate-like structure. When the wire connector 200 and the board connector 100 are connected to each other, the two external limiting structures 29 may correspond in position to the outer side of the metal shell 13.

The board connector 100 of the present embodiment is the same as the board connector 100 of the first embodiment. The two first guide structures 134 of the board connector 100 may be formed by bending the metal shell 13, and are defined as a first inner guide structure 134A and a first outer guide structure 134B in pairs.

The wire connector 200 can include two types of second guide structures that are respectively defined as a second inner guide structure 28A and a second outer guide structure 28B. The second inner guide structure 28A may be formed on an outer surface of the inner limiting structure. The second outer guide structure 28B may be formed on an inner surface of the external limiting structure 29.

When the wire connector 200 and the board connector 100 are connected to each other, the first inner guide structures 134A will respectively engage with the second inner guide structures 28A, and the first outer guide structures 134B will respectively cooperate with the second outer guide structures 28B. In other words, the second inner guide structures 28A and the second outer guide structures 28B are spaced apart from each other to accommodate corresponding ones of the first inner guide structure 134A and first outer guide structure 134B in pairs on the metal shell 13. It should be noted that in different embodiments, the metal shell 13 may include only the first outer guide structure 134B, without the first inner guide structure 134A. Correspondingly, the wire connector 200 may also include only the second outer guide structure 28B, without the second inner guide structure 28A. In one of the embodiments where the board connector 100 only includes a single type of first guide structure, the first guide structure can be exemplified to be a solid convex column structure. Through the second guide structure 28 of the limiting structure (including the first inner limiting structure 26A, the second inner limiting structure 26B, and the external limiting structure 29) of the wire connector 200 and the first guide structure 134 of the metal shell 13, the wire connector 200 can move along the mating direction when inserted into or removed from the board connector 100. Accordingly, the tilting issue caused by different insertion and withdrawal forces for different type slots on the wire connector 200 can be suppressed.

### Third Embodiment

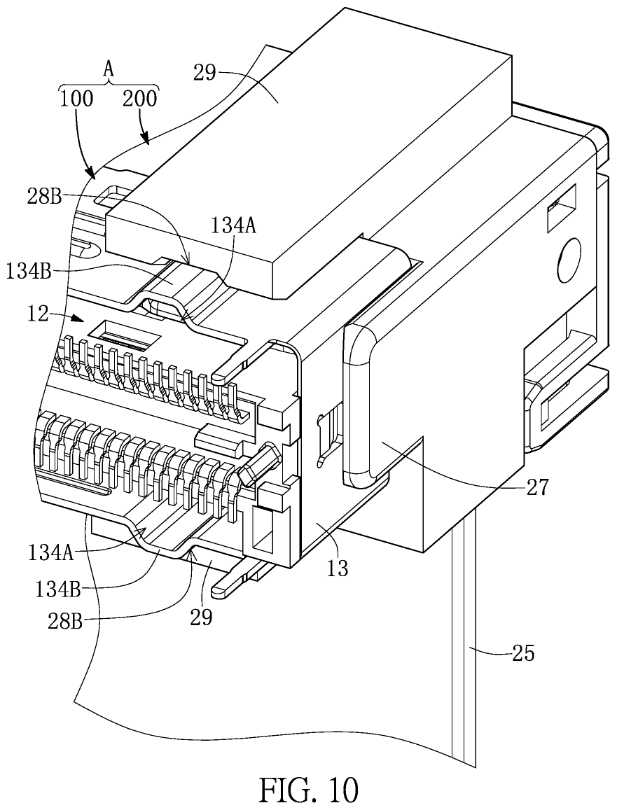

Referring to FIG. 10, FIG. 10 is a schematic enlarged view of a section of the connector assembly according to a third embodiment of the present disclosure. The difference between the present embodiment and the second embodiment in FIG. 9 mainly lies in that the first inner guide structure 134A, the first outer guide structure 134B, the second inner guide structure 28A and the second outer guide structure 28B have different outer appearances.

### Fourth Embodiment

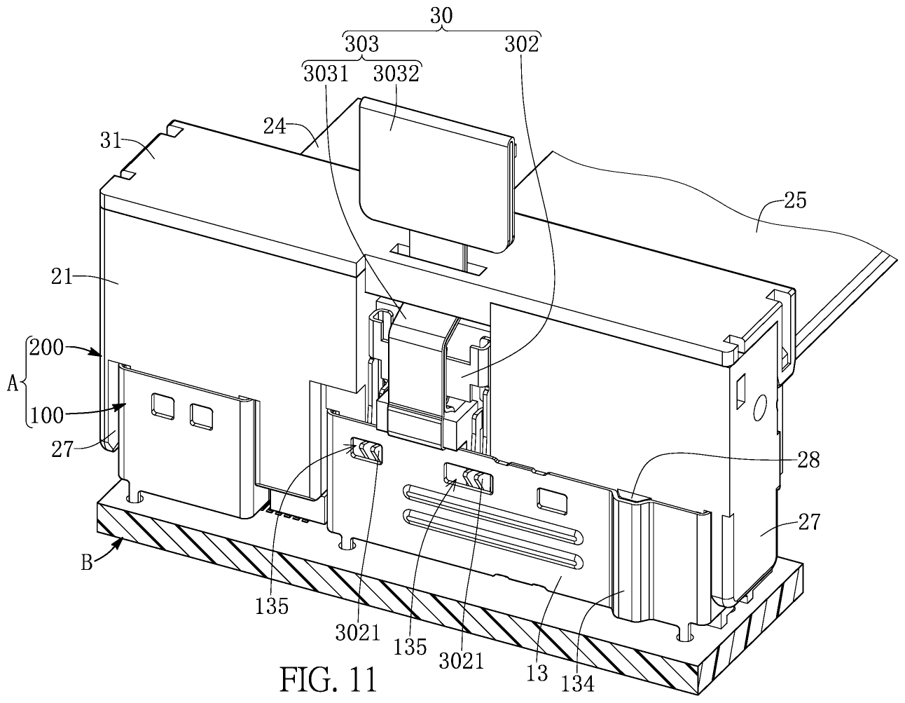

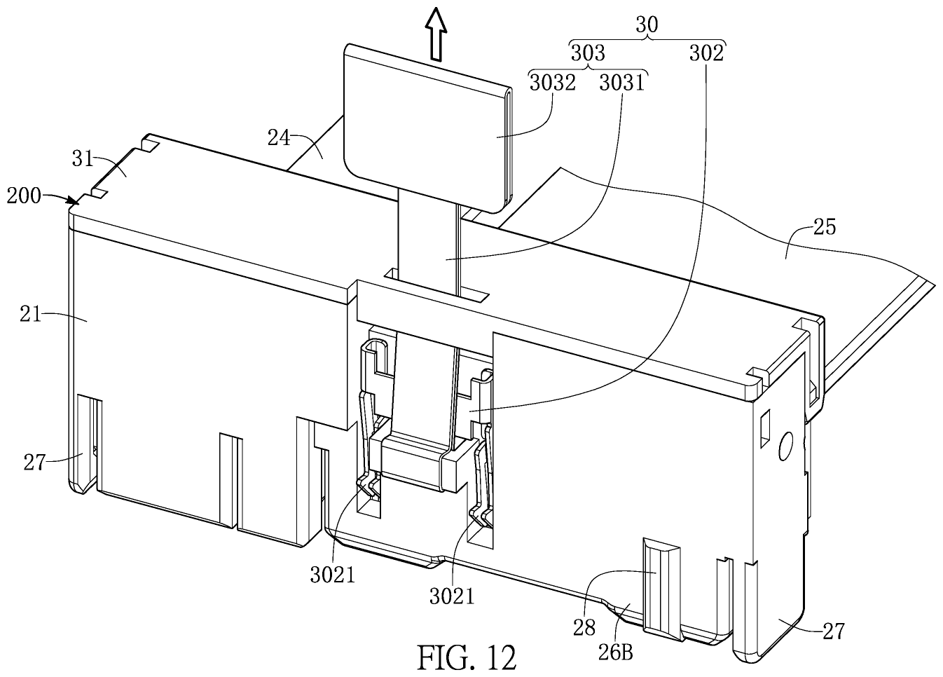

Referring to FIG. 11 to FIG. 12, FIG. 11 is a schematic view of a section of the connector assembly in a mated state according to a fourth embodiment of the present disclosure, and FIG. 12 is a schematic operational view of the wire connector of the connector assembly according to the fourth embodiment of the present disclosure.

One difference between the present embodiment and the second embodiment mainly lies in that one of the second guide structures 28 provided on the outer side of one of the inner limiting structures 26B of the wire connector 200 (opposite to the side facing the second connecting plate 23) may be a solid columnar structure.

Another difference between the present embodiment and the second embodiment mainly lies in that the board connector 100 includes a single first connecting seat 11 and a single second connecting seat 12, and the wire connector 200 includes a single first connecting plate 22 and a single second connecting plate 23.

The metal shell 13 of the board connector 100 also includes a plurality of first buckle structures 135, and each of the first buckle structures 135 can be a through hole or a groove on the metal shell 13. The first buckle structures 135 are correspondingly disposed on the first connecting seat 11 and/or the second connecting seat 12. The wire connector 200 also includes an operating mechanism 30, and the operating mechanism 30 includes an elastic component 302 and a drawstring 303. The elastic component 302 is disposed on an outside surface of the inner limiting structure 26B. The elastic component 302 includes a plurality of second buckle structures 3021, and the second buckle structures 3021 may be outward hooks or bumps. The drawstring 303 includes a drawstring body 3031 and a holding portion 3032, one end of the drawstring body 3031 is fixed on the insulating body 21, and the other end of the drawstring body 3031 is connected to the holding portion 3032. A part of the drawstring body 3031 is located in an outer side of the elastic component 302.

When the wire connector 200 and the board connector 100 are connected to each other, the first buckle structures 135 and the second buckle structures 3021 engage with each other. When the holding portion 3032 of the drawstring 303 is held and pulled along a direction away from the insulating body 21, a segment of the drawstring 303 located on the elastic component 302 causes the elastic component 302 to move inwardly (i.e., a free end of the elastic component 302 is pressed inwardly), so that the elastic component 302 undergoes elastic deformation and the second buckle structures 3021 will correspondingly move away from the first buckle structures 135. Accordingly, the second buckle structures 3021 will no longer engage with the first buckle structures 135.

By virtue of the first buckle structures 135 and the second buckle structures 3021, the wire connector 200 and the board connector 100 can be connected more firmly. Moreover, through the design of the operating mechanism 30, users can easily and quickly disengage the second buckle structures 3021 from the first buckle structures 135.

### Fourth to Eighth Embodiments

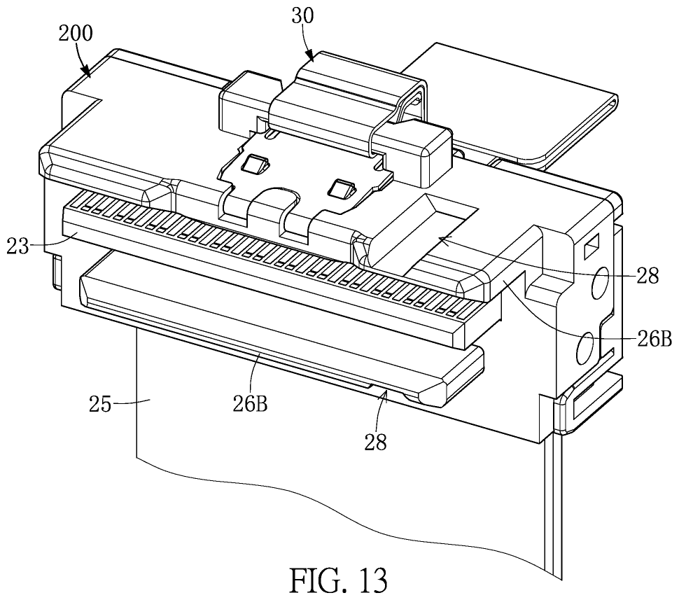

Referring to FIG. 13 to FIG. 16, FIG. 13 to FIG. 16 are schematic views of wire connectors according to fifth to eighth embodiments of the present disclosure. In any one of the aforementioned embodiments, the connector assembly is exemplified to be a single wire connector including a first connecting plate and at least one second connecting plate. The connector assembly of the present disclosure is not limited thereto. In different embodiments, the connector assembly may include two or more wire connectors, one of the wire connectors only includes the first connecting plate, and another one of the two wire connectors only includes the second connecting plate for being respectively connected to a first connecting seat 11 and a second connecting seat 12 of the board connector 100.

Referring to FIG. 13, FIG. 13 is a schematic view of the wire connector 200 including a single second connecting plate 23. In the present disclosure, two inner limiting structures 26B of the wire connector 200 may be located on both sides of the second connecting plate 23, and the outer sides of the two inner limiting structures 26B (that are opposite to a side facing the second connecting plate 23) can each be concavely formed to have a second guide structure 28. The quantity and placement of the second guide structures 28 shown in FIG. 13 can be varied according to requirements.

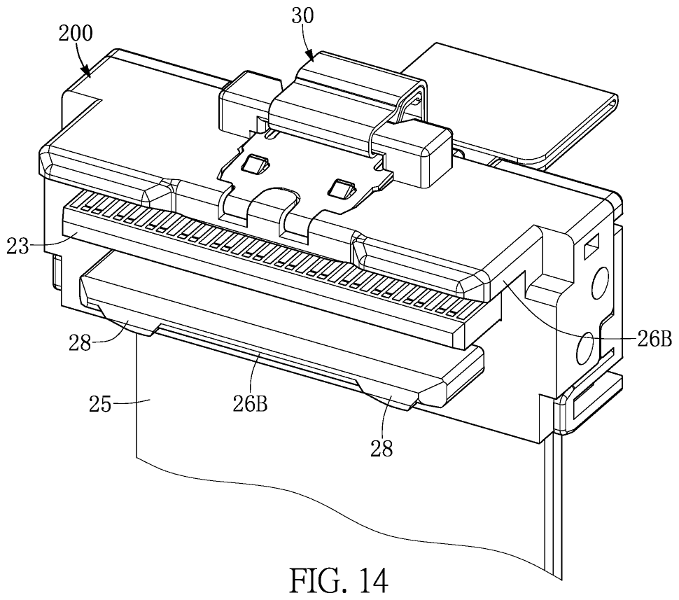

Referring to FIG. 14, in another variant embodiment, the wire connector 200 including the single second connecting plate 23 may also include two inner limiting structures 26B, and only one of the two inner limiting structures 26B includes two second guide structures 28. The two second guide structures 28 may be located on the outer side of one of the inner limiting structures 26B (that is opposite to the side facing the second connecting plate 23), and the other inner limiting structure 26B (i.e., the inner limiting structure 26B provided with the operating mechanism 30) may not be provided with a second guide structure 28. The quantity and placement of the second guide structures 28 shown in FIG. 14 can be varied according to requirements.

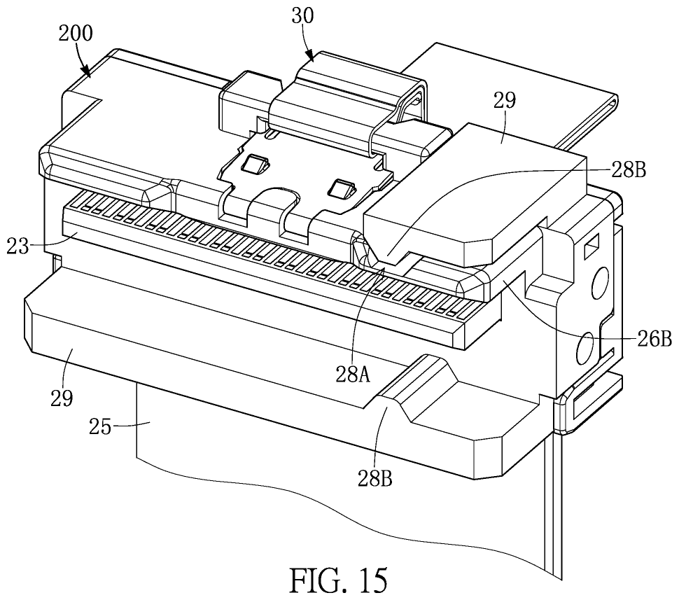

Referring to FIG. 15, in yet another variant embodiment, the wire connector 200 including the single second connecting plate 23 may include one inner limiting structure 26B and two external limiting structures 29 that are located outside of the metal shell 13 when the wire connector 200 is connected with the board connector 100. The inner sides of the two external limiting structures 29 may each have a second outer guide structure 28B, and the outer side of the inner limiting structure 26B of the wire connector 200 may have a second inner guide structure 28A. The quantity and placement of the external limiting structures 29 shown in FIG. 15 can be varied according to requirements, and the quantity and placement of the second outer guide structures 28B and the second inner guide structures 28A shown in FIG. 15 can also be varied according to requirements.

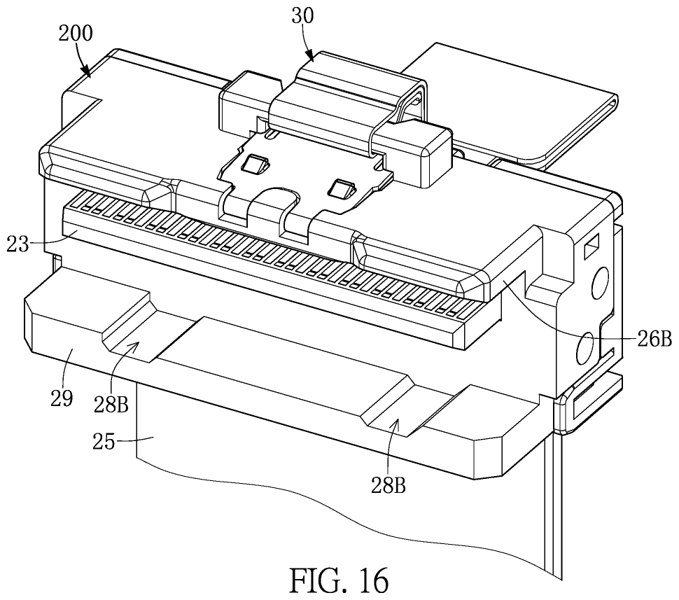

Referring to FIG. 16, in still another variant embodiment, the wire connector 200 including the single second connecting plate 23 may include a single external limiting structure 29 disposed on one side of the second connecting plate 23 (opposite to the side of the operating mechanism 30). The inner side of the external limiting structure 29 (facing the second connecting plate 23) can include two second outer guide structures 28B. The quantity and placement of the second outer guide structures 28B shown in FIG. 16 can be varied according to requirements.

It should be noted that, in practical applications, the second connecting plate shown in FIG. 13 to FIG. 16 can be easily adjusted to become the first connecting plate. The dimensions of the wire connector and other components included in the wire connector can be adjusted according to practical requirements, so that the wire connector shown in FIG. 13 to FIG. 16 can be applied as a wire connector that includes a single first connecting plate. Even though the wire connector 200 shown in FIG. 13 to FIG. 16 does not display anti-tilt insertion structures, in practical applications, the wire connector 200 can have connectors with single-sided anti-tilt insertion structures (corresponding to the outermost connection seat). In addition to preventing tilt insertion into the board connector 100, the wire connector also features an anti-fooling function to avoid the wire connector 200 from being mistakenly inserted into other connecting seats.

It should be noted that, in the above-mentioned embodiments, the terms “first,” “second,” and “inner” used to describe the first inner limiting structure, the second inner limiting structure, and external limiting structure are merely adjectives adopted for the convenience of explanation in the embodiments. In fact, the first inner limiting structure, the second inner limiting structure, and external limiting structure all belong to a single type of limiting structure.

In conclusion, in the connector assembly provided by the present disclosure, by virtue of “the first guide structure, the second guide structure, the operating mechanism, and anti-tilt insertion structure,” whether used individually or in combination, it can prevent the components of the wire connector from easily getting damaged (e.g., bending, breaking) during the insertion or removal process from the board connector.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A connector assembly, comprising:
a board connector configured to be fixed on a circuit board, wherein the board connector includes:
at least one first connecting seat disposed on the circuit board, wherein the at least one first connecting seat includes a first connecting slot;
at least one second connecting seat disposed on the circuit board, wherein the at least one second connecting seat includes a second connecting slot that is different from the first connecting slot; and
a metal shell, wherein the at least one first connecting seat and the at least one second connecting seat are surrounded by the metal shell, and the metal shell includes at least one first guide structure; and
at least one wire connector configured in being inserted into the board connector, wherein the at least one wire connector includes at least one second guide structure;
wherein, when the at least one wire connector is inserted into or removed from the board connector, the first guide structure and the second guide structure is capable of cooperating with each other, so as to guide the at least one wire connector in being inserted into or removed from the board connector.

2. The connector assembly according to claim 1, wherein the at least one first connecting seat is configured to transmit power, the at least one second connecting seat is configured to transmit signals, and the at least one first connecting seat and the at least one second connecting seat are arranged in a row.

3. The connector assembly according to claim 1, wherein the first guiding structure is formed by bending a segment of the metal shell.

4. The connector assembly according to claim 1, wherein a gap is between the metal shell and each of two long side walls of the at least one second connecting seat.

5. The connector assembly according to claim 1, wherein the wire connector includes an insulating body, at least one first connecting plate, at least one second connecting plate, and at least one inner limiting structure; wherein, when the wire connector is inserted into the board connector, the at least one first connecting plate and the at least one second connecting plate are respectively inserted into the at least one first connecting slot and the at least one second connecting slot, and at least one inner limiting structure is located between the metal shell and the second connecting seat or between the metal shell and the first connecting seat; wherein the second guide structure is formed on the at least one inner limiting structure.

6. The connector assembly according to claim 5, wherein a first gap is between the metal shell and each of two long side walls of the at least one first connecting seat, and a second gap is between the metal shell and each of two long side walls of the at least one second connecting seat, wherein the at least one inner limiting structure is configured by being inserted into one of the first gap or the second gap.

7. The connector assembly according to claim 1, wherein the wire connector includes an insulating body, at least first connecting plate, at least second connecting plate, and at least one external limiting structure; wherein, when the wire connector is inserted into the board connector, the at least one first connecting plate and the at least one second connecting plate are correspondingly inserted into the at least one first connecting slot and the at least one second connecting slot, and the at least one external limiting structure is located outside the metal shell; wherein the second guide structure is formed in the at least one external limiting structure.

8. The connector assembly according to claim 1, wherein the metal shell includes two first side walls and two second side walls, two ends of each of the two first side walls are respectively connected to two ends of each of the two second side walls, the two first side walls are arranged facing each other, and the two second side walls are arranged facing each other; wherein the metal shell includes a plurality of first guide structures, and a quantity of the first guide structures is an even number; wherein half of the first guide structures are provided on one of the two second side walls, another half of the first guide structures are provided on another one of the two second side walls, and any one of the first guide structures is arranged facing another one of the first guide structures.

9. The connector assembly according to claim 1, wherein the metal shell includes a plurality of first buckle structures, and the wire connector includes an operating mechanism; wherein the operating mechanism includes an elastic component and a drawstring, and the elastic component includes a plurality of second buckle structures; wherein one of two ends of the drawstring is fixed to the insulating body, and another one of the two ends of the drawstring is connected to a holding portion; wherein, when the wire connector and the board connector are connected to each other, the first buckle structures and the second buckle structures engage with each other; wherein, when the holding portion of the drawstring is pulled away from the insulating body, the elastic component is configured to be directed inwardly, so that the second buckle structure moves away from the first buckle structure.

10. The connector assembly according to claim 1, wherein the wire connector includes an insulating body, at least one first connecting plate and at least one second connecting plate; wherein two anti-tilt insertion structures are respectively located on two sides of one end of the insulating body, one of two ends of each of the two anti-tilt insertion structures is fixed to one of two opposite sides of an end surface of the insulating body, and another one of the two ends protrudes from the end surface; wherein, when the wire connector is inserted into the board connector, the two anti-tilt insertion structures correspond in position outside the metal shell.

11. A wire connector for connecting with a board connector having a metal shell, comprising:
an insulating body;
a first connecting plate disposed on an end surface of the insulating body and being perpendicular to the end surface, wherein a surface of the first connecting plate has a plurality of first gold fingers;
a first ribbon wire electrically connected to the first gold fingers of the first connecting plate, wherein the first ribbon wire protrudes from a side surface that is adjacent to the end surface; and
at least one limiting structure protruding vertically from the end surface and being parallel to the first connecting plate, wherein the at least one limiting structure has a second guide structure to match a first guide structure on the metal shell, so as to guide the wire connector in being inserted into or removed out of the board connector.

12. The wire connector according to claim 11, wherein the limiting structure is located between the first connecting plate and the first ribbon wire.

13. The wire connector according to claim 11, wherein the quality of the limiting structure is two or more, and two of the limiting structures are respectively located on two opposite sides of the first connecting plate.

14. The wire connector according to claim 11, further comprising two anti-tilt insertion structures located on two opposite sides of the end surface, wherein the two anti-tilt insertion structures are perpendicular to the end surface and the first connecting plate.

15. The wire connector according to claim 11, further comprising a second connecting plate, wherein the second connecting plate is disposed on the end surface and is perpendicular to the end surface; wherein the second connecting plate is arranged in a row with the first connecting plate.

16. The wire connector according to claim 15, wherein the second connecting plate has a plurality of second gold fingers, and a width of at least one of the second gold fingers is different from a width of at least one of the first gold fingers.
